(19) United States
(12) Patent Application Publication
(10) Pub. No.: US 2003/0059014 A1
(43) Pub. Date: Mar. 27, 2003

(54) Multi-media communication management system with caller managed hold system

(75) Inventors: Rodney A. Ross, Fairlawn, OH (US); Robert M. Nebiker, Naples, FL (US)

Correspondence Address: TIMOTHY P. O'HAGAN, 8710 KILKENNY CT, FORT MYERS, FL, 33912, US

(73) Assignee: Teleware, Inc., Akron, OH (US)

(21) Appl. No.: 10/096,560

(22) Filed: Mar. 13, 2002

Related U.S. Application Data
(63) Continuation-in-part of application No. 09/961,532, filed on Sep. 24, 2001.

(51) Int. Cl. H04M 3/42; H04M 7/00

(52) U.S. Cl. 379/201.01; 379/219

(57) ABSTRACT

The caller managed hold system enables a caller, when their incoming call is placed in a hold state, to manage the program materials that are transmitted to them. In addition, the identity of the caller and their customization of the program material choices are stored in memory to be used for any subsequent calls received from the caller. In this manner, the caller automatically receives a customized hold service whenever their call is placed in a hold state.

### CROSS REFERENCE TO RELATED APPLICATIONS

The present application is a continuation in part of U.S. patent application Ser. No. 09/961,532 titled Teledata Space and Docking Station with Modular and Integrated Display filed on Sep. 24, 2001 the contents of this patent application are incorporated herein.

### FIELD OF THE INVENTION

This invention relates to multi-media communication management systems, and, in particular, to a system providing a caller managed hold service that provides the caller with the ability to customize the program material that is transmitted while their incoming call is in a hold state.

Problem

It is a problem in telephone switching systems to provide a caller with appropriate program materials while the incoming call is in a hold state. Existing “music on hold” systems provide only a single port to which program materials can be coupled. The program materials provided to a caller while on hold either is advertising data or entertainment materials. The entertainment materials typically consist of a commercially available program source, such as a radio station, or prerecorded music. If the caller does not enjoy the selected program materials, the hold state represents a source of frustration to the caller, thereby rendering the service counterproductive. One known solution are systems that permit a caller to turn the program material off, typically by pressing a designated number key. While such a solution helps alleviate the problem, it is not optimal.

Solution

The above-described problems are solved and a technical advance achieved by the present multi-media communication management system with a caller managed hold system (termed “caller managed hold system” herein). The caller managed hold system enables a caller, when their incoming call is placed in a hold state, to manage the program materials that are transmitted. In addition, the identity of the caller and their customization of the program material choices are stored in memory to be used for any subsequent calls received from the caller. In this manner, the caller automatically receives a customized hold service whenever his or her call is placed in a hold state.

### BRIEF DESCRIPTION OF THE DRAWINGS

FIG. 1 is a block diagram view of a modular multi-media communication management system that is equipped with the present caller managed hold system;

FIG. 2 is a block diagram of a multi-media communication management system controller;

FIG. 3 is a perspective exploded view of a modular communication space station that is served by the modular multi-media communication management system that is equipped with the present caller managed hold system;

FIG. 4 is a block diagram of a communication space station that is served by the modular multi-media communication management system that is equipped with the present caller managed hold system;

FIG. 5 is a flow diagram representing routing of an incoming call in accordance with one embodiment of the present invention;

FIG. 6 is a flow diagrams that represents the operation of the caller managed hold system;

FIG. 7 is a representation of a on-hold programming menu presented to a caller on hold in accordance with one embodiment of the present invention; and

FIG. 8 is a block diagram representing the exemplary hold module.

### DETAILED DESCRIPTION OF THE DRAWINGS

The present caller managed hold system is now described in detail with reference to the drawings. In the drawings, each element with a reference number is similar to other elements with the same reference number independent of any letter designation following the reference number. It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

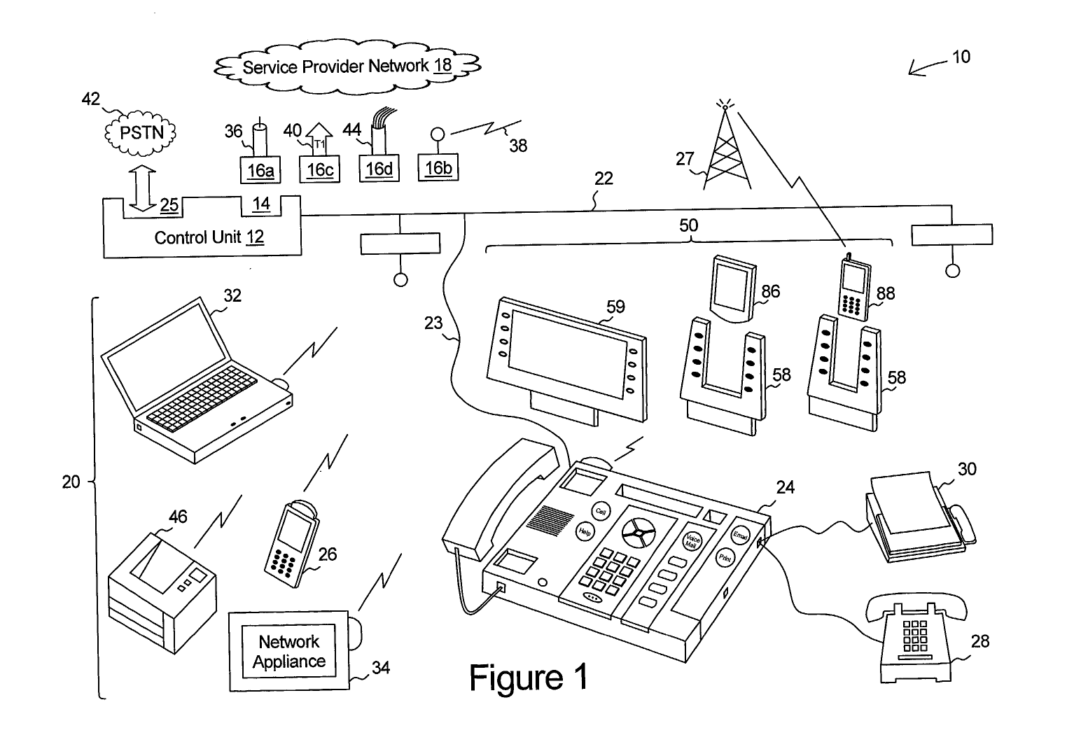

FIG. 1 illustrates a multi-media communication management system 10 that includes the present caller managed hold system. The multi-media communication management system 10 includes a control unit 12 that is coupled with a plurality of local communication devices 20 over a wireless Local Area Network 22 (or by a wired network connection 23 to the backbone wired network of the wireless Local Area Network 22). The local communication devices 20 may include: subscriber stations 24 (communication space stations 24), wireless dialog handsets 26, traditional telephone handsets 28, traditional fax machines 30 (both coupled through communication space station 24), traditional computer systems 32, network printers 46, and various network appliances 34.

The control unit 12 includes a circuit switched provider bay 25 which operatively couples the control unit 12 to one or more subscriber loops of the Public Switched Telephone Network (PSTN) 42 and includes a multi-media communication service provider bay 14 which operatively couples the control unit 12 to a multi-media Service Provider network 18 through one of a plurality of communication medium modules 16a-16d. In the exemplary embodiment, the multi-media Service Provider network 18 may utilize the Internet Protocol Suite for communication at the IP level, but may be proprietary at the data link and physical layers. As such, the control unit 12 includes the IP stacks applicable for communication between applications over the multi-media Service Provider network 18 and each module 16a-16d includes the applicable data link and physical layer circuits for communication of IP frames over the physical medium of the multi-media Service Provider network 18a-18d.

Some illustrative examples of communication modules include: communication module 16a which may be a cable modem module for communicating over coaxial cable 36 with a multi-media communication service provider such as a local cable company, communication module 16b which may be a wide area network radio for communication over a wireless spectrum channel 38 with a wide area wireless multimedia communication service provider such as an analog or digital cellular/PCS telephone service provider, communication module 16c which may be a customer service unit (CSU) for communication over a T1 line 40 with a multi-media communication provider such as a local telephone service provider, and communication module 16d which may be an optical modem for communication over a fiber channel 44 with a fiber optic multi-media communication service provider. In operation, the control unit 12 integrates and manages multi-media communication between two or more local communication devices 20 and between each local communication device 20 and a remote communication system(s) (not shown) coupled to either the multi-media Service Provider network 18 or the Public Switched Telephone Network 42.

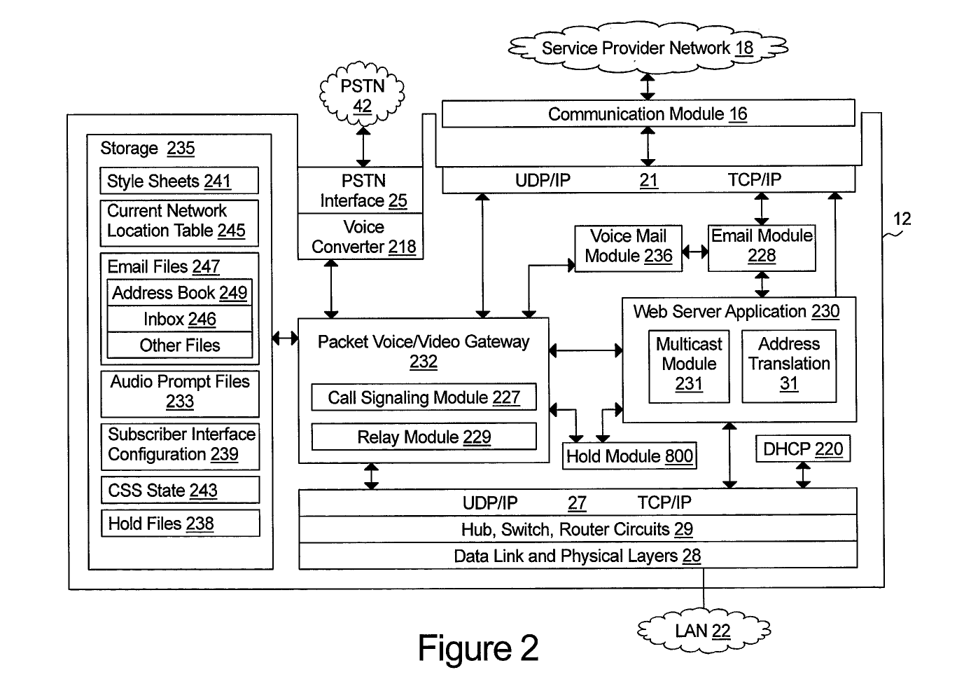

FIG. 2 shows a block diagram of control unit 12. The control unit 12 includes applicable modules for managing the Local Area Network 22 as an IP network. Such modules may include an applicable combination of hubs, routers, and switches 29 for managing communications over the Local Area Network 22 as well as an address server 220 (e.g. DHCP server) for assigning local IP addresses to each local communication device 20. The control unit 12 may also include a packet audio/video gateway 232, an audio mail module 236, an e-mail module 228, a caller hold module 800, and a web server application 230.

The packet audio/video gateway 232 provides a subscriber's real time full duplex audio communication and audio/video communication services. The services may include routing and maintaining a subscriber's outgoing calls and incoming calls. A subscriber's outgoing calls may comprise audio calls, audio/video calls, and multi-party conference calls (either audio or audio/video) that are originated by a communication space station 24 that is associated with the subscriber. The destination(s) may be remote packet audio/video devices coupled to the multi-media Service Provider network 18, remote telephones coupled to the Public Switched Telephone Network 42, or other subscriber's served by the multi media communication management system 10. A subscriber's incoming calls may comprise calls (either audio or audio/video) that are originated by a remote telephone device coupled to the Public Switched Telephone Network 42, remote packet audio/video devices coupled to the multi-media Service Provider network 18, or other communication space stations 24.

The packet audio/video gateway 232 communicates over the Local Area Network 22 and the multi-media Service Provider Network 18 utilizing IP protocols as discussed herein and communicates over the Public Switched Telephone Network 42 utilizing analog or Public Switched Telephone Network digital signals. As such, the control unit 12 includes a Public Switched Telephone Network interface 25 that includes circuits for translating between the Public Switched Telephone Network call signaling with its analog or digital audio communication and the call signaling and digital audio communication formats and protocols used by the packet audio/video gateway 232. Therefore, for the sake of simplicity, the discussion of the packet audio/video gateway 232 herein refers to Public Switched Telephone Network interface 25 as an originating or destination device with which a audio call may be established and maintained. However, it should be appreciated that the Public Switched Telephone Network interface 25 is not the ultimate origination or destination but is operating to interface the packet audio/video gateway 232 to a remote telephone system on the Public Switched Telephone Network 42 with which it could not communication directly.

The packet audio/video gateway 232 includes a call signaling module 227. The call signaling module 227 includes circuits for receiving call signaling messages from an originating device, identifying a destination device, providing call signaling messages to the destination device, and, if responded to by the destination device, proxying the negotiation of compression algorithms and channel usage for the relay of real time audio or audio/video communications. For inbound calls, the call signaling message provided by the originating device may identify a subscriber served the multi-media communication management system 10. The call signaling module 227 identifies the communication space station 24 at which the subscriber is presently located (by identifying the communication space station that is presently serving the subscriber device 50 that is assigned to the subscriber) so that the inbound call may be routed to the subscriber.

The caller hold module 800 provides “on-hold” audio or audio/video programming to a caller that may be placed “on-hold” by a subscriber operating a communication space station 24 or by the packet gateway 232 performing communication management functions. Referring briefly to FIG. 8 in conjunction with FIG. 2, the caller hold module 800 includes directory circuits 802 for accessing a plurality of audio or audio/video program files stored as compressed audio or audio/video data files 238 within Storage 235.

The hold module 800 further includes real time programming client circuits 804 that may establish a real-time streaming media channel to a remote programming provider's server coupled to the Service Provider network 18 to obtain audio or video programming to provide as “on-hold” programming. For example, a radio station or TV station may multi-cast programming or the Internet and the hold module may join its multi-cast group.

The caller hold module 800 also includes hold management circuits 806 that provide an audio or video menu of hold programming choices to a caller, receive a caller selection of a programming choice, provide the selected programming to the caller, and store the caller's selection in association with the caller ID information such that the same selection can be provided to the caller in future calls.

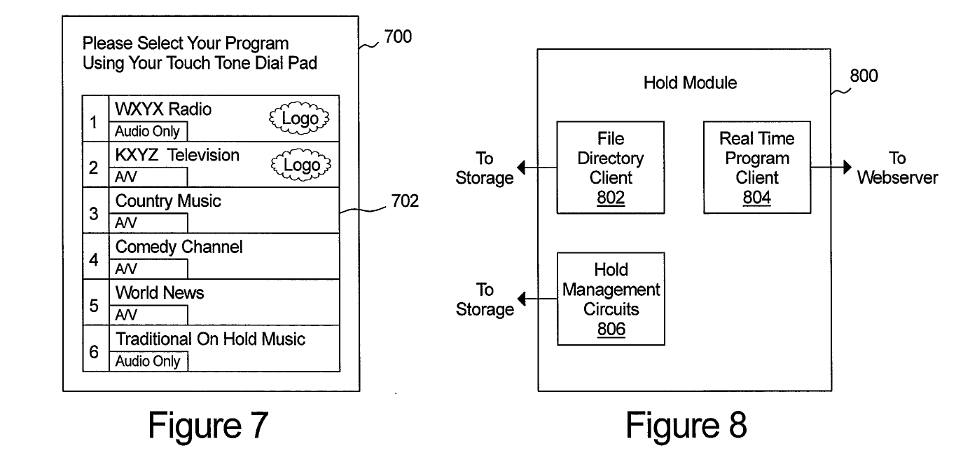

Turning briefly to FIG. 7, an exemplary graphic display 700 of a menu of call hold programs 702 is shown. Such a display may be provide to the caller's system utilizing the systems and methods of a video conference call or may be provided using the systems and methods of a web server providing document information to a client.

The menu of call hold programs 702 may include a list of available programs that include compressed prerecorded audio (and/or audio/video) files or real time audio (and/or audio/video) feeds available from remote service providers. To provide advertising for remote service providers, the service providers logo or other graphic image may be included within the menu 702.

Caller Managed Hold System

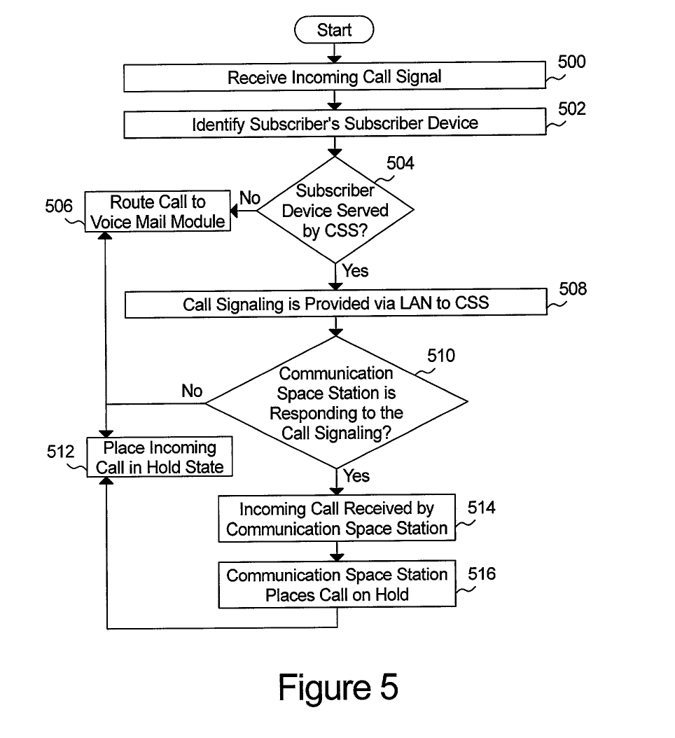

FIGS. 5 & 6 illustrate in flow diagram form, the operation of call signaling by the packet gateway 232 and operation of the caller hold module 800 respectively. At step 500, the multi-media communication management system 10 receives an incoming call signal via a one of the communication media, such as the Public Switched Telephone Network 42 or the service provider network 18. The call signaling message identifies the subscriber who is the called party and may include caller ID information such as the caller's name and/or PSTN telephone number.

Each subscriber served by the multi-media communication management system 10 is assigned a subscriber identifier number that corresponds to a Public Switched Telephone Network direct dial number that routes to the Public Switched Telephone Network Interface 25 when dialed on the Public Switched Telephone Network 42. As such, the call signal, whether provided by an originating device coupled to multi-media Service Provider network 18, an originating device coupled to Local Area Network 22, or the Public Switched Telephone Network Interface 25, may include the subscriber identifier number to identify the destination subscriber.

At step 502, the call signaling module 227 identifies a subscriber device 50 (FIG. 1) that is associated with the identified subscriber by utilizing the network location table 245 that is maintained in memory 235. To associate each subscriber with their subscriber device 50, the network location table 245 includes a record for each subscriber. Within such record are a plurality of data fields that identify: the subscriber, the subscriber identifier associated with the subscriber, a subscriber device ID code that is unique to the subscriber device 50 that is assigned to the subscriber, and a network address of a communication space station 24, if any, that is presently serving the subscriber's subscriber device. The address within this field is updated when the subscriber moves their subscriber device 50 from one communication space station 24 to another.

At step 504, the call signaling module 227 identifies whether the subscriber's subscriber device 50 is served by a communication space station 24 by reference to the network location table 245. If the subscriber device 50 is not presently served by any communication space station 24, then the network location table 245 will so indicate. If the call signaling module 227 determines that the subscriber device 50 assigned to the subscriber is not presently served by any communication space station 24, the voice mail module 236 becomes the default destination device to which the call is established at step 506. However, if the subscriber device 50 is served by a communication space station 24, such communication space station 24 becomes the destination device to which call signaling is provided at step 508 via Local Area Network 22.

The call signaling module 227 determines at step 510 whether the communication space station 24 is responding to the call signaling. In certain events, such as when the subscriber is already engaged in a telephone call or if the subscriber does not answer the inbound call, the communication space station 24 does not respond to the call signaling. In these cases, the voice mail module 236 can be the default destination device at step 506, or the incoming call may be placed in a hold state at step 512 if the subscriber is already engaged in a telephone call until the communication space station 24 is available to receive the incoming call. The incoming call may be received by the communication space station 24 at step 514. If the subscriber at communication space station 24 subsequently places the call on hold at step 516, processing advances to step 512.

The above described steps are exemplary steps that may result in the packet gateway 232 placing a call on hold. However, this invention contemplates other steps and schemes including auto attendant functionality, conference call management, and other functions that may result in the packet gateway 232 placing a call on hold.

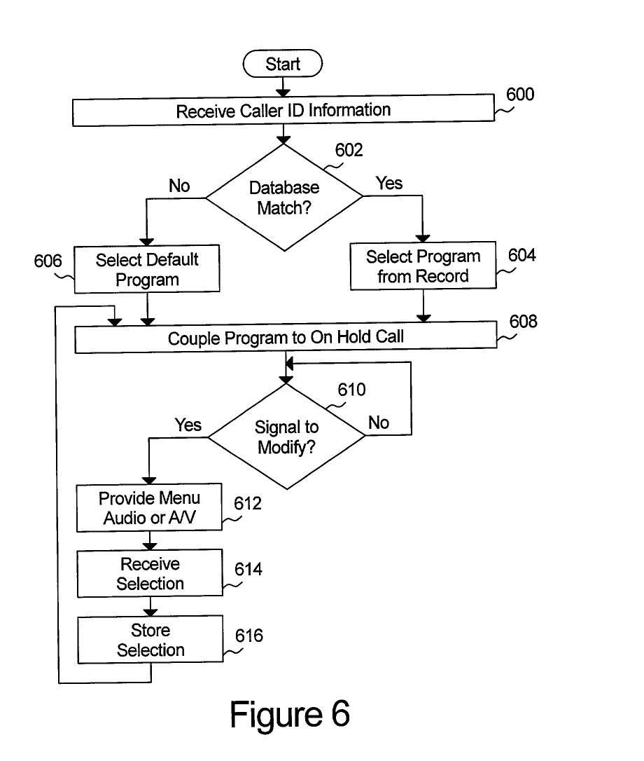

Once placed on hold, audio or audio/video hold programming may be provided by the hold module 228. At step 600 (of FIG. 6), the hold module 800 is provided with the caller ID information associated with the on-hold call. Step 602 represents accessing the hold files 238 (FIG. 2) to determine if the PSTN number of the Caller ID information matches a record in the database.

If there is a match, the module 800 identifies a programming selection from the matching record at step 604 and couples the on-hold call to such program selection at step 608. The program selection may be either an audio or audio/video file from the compressed hold files 238 or maybe a selection retrievable over the Network 18 by the real time programming client.

If there is not a matching record, the module 800 selects a default programming selection at step 606 and couples the on-hold call to such programming at step 608.

It should be appreciated that the programming selection in the record may be a programming selection: a) previously selected by a caller from the record's PSTN number; b) selected based on the PSTN number's geographic location; c) selected based on past inquiries and/or purchases made from the PSTN number; or d) other schemes for selecting programming utilizing information known about past calls from the PSTN number to provide programming content with a probability of being more useful or desirable to the caller than generic programming.

Step 610 represents receiving a signal indicating caller desire to modify on hold programming, and step 612 represents providing either an audio or video menu of available selections. If the call is a video call, the menu will be provided in video format as an image replacing the video image.

Step 614 represents receiving a programming selection from the caller, and step 616 represents providing the programming selection. 618 represents storing the programming selection in a database in the record associated with the PSTN number.

Communication Space Station

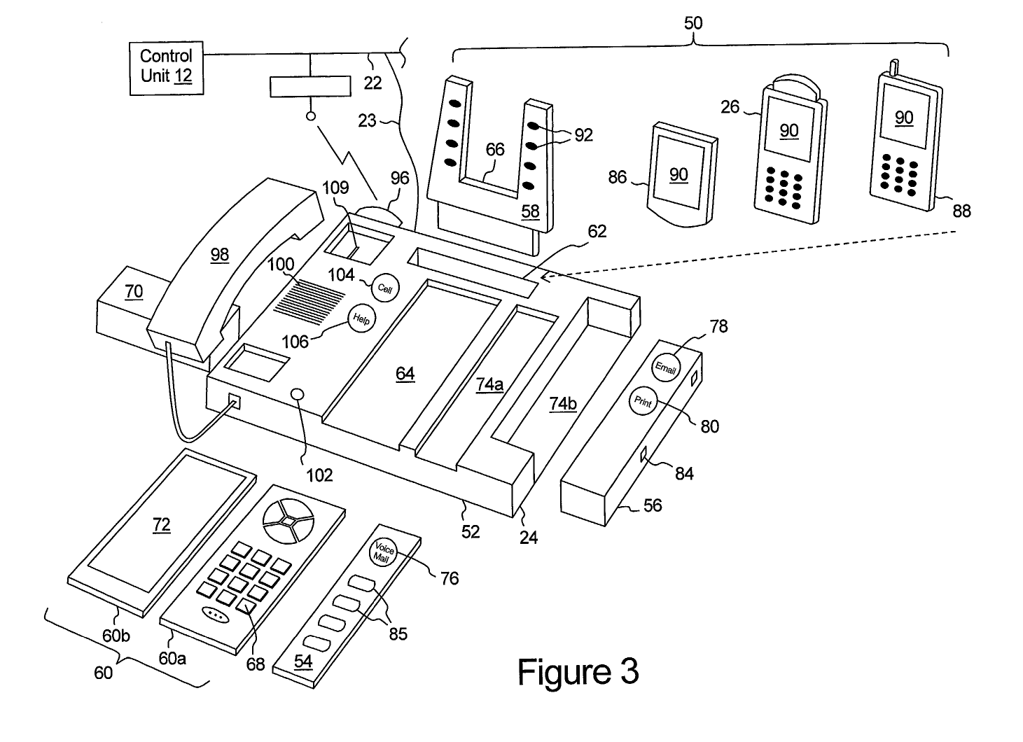

FIG. 3 illustrates, in a perspective view, a communication space station 24. The communication space station 24 includes a platform unit 52 that operatively couples to the control unit 12 via either a wireless communication link between a platform unit network circuit 96 and the wireless Local Area Network 22 or a direct network connection 23 between the platform unit 52 and the backbone network of the wireless Local Area Network 22.

A plurality of functional modules 54, 56, 58, 60, and 11 may be coupled to the platform unit 52 to form an integrated multi-media communication platform. The platform unit 52 includes a subscriber interface docking platform 64 for coupling and optionally supporting one of a plurality of modular subscriber interface units 60 to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a first function specific docking platform 74a and a second function specific docking platform 74b, each of which couples to a plurality of function specific modules 54 and 56. The first function specific docking platform 74a is a shallow platform for coupling to function specific modules that primarily comprise function specific buttons or other circuits that may be placed within a thin module. The second function specific docking platform 74b is a larger platform for coupling to function specific modules with more complex internal circuits requiring the additional size. In the exemplary embodiment, the function specific module 54 may include subscriber interface buttons configured for enhancing audio communication through the communication space station 24 such as an audio message control 76 for single button access to audio message files and audio management controls 85 for single button control of enhanced audio management functions. The function specific module 56 may include circuits configured for enhancing data communication through the communication space station 24 such as an e-mail control 78 for single button access to subscriber e-mail messages, a print control 80 for single button initiation of the printing of an e-mail message, and a data networking port 84.

The platform unit 52 further includes a docking bay 62 into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN audio handset 26, each of which is discussed in more detail herein. While operatively coupled to the platform unit 52, the subscriber device 50 becomes an integral part of the subscriber interface of the communication space station 24. A liquid crystal graphic display 90 on the subscriber device 50 may function to display multi-media communication management information under control of the platform unit 52 and the control unit 12. Further, programmable subscriber controls 92 positioned adjacent to the subscriber device 50 may be configured to activate platform unit 52 and control unit 12 functions in accordance with the contents of the graphic display 90 adjacent to the controls 92.

The platform unit 52 may further include one or more of the following elements: a handset 98 similar to a traditional telephone handset to provide a subscriber audio interface, a speaker 100 and a microphone 102 to provide a hands-free subscriber audio interface, a modular battery pack 70 (which fits within a battery pack bay that is not shown) for operating power when the communication space station 24 is uncoupled from a line voltage, cell button 104 for single button selection of certain functions such as a wide area network communication function, and help button 106 for single button selection of a help function.

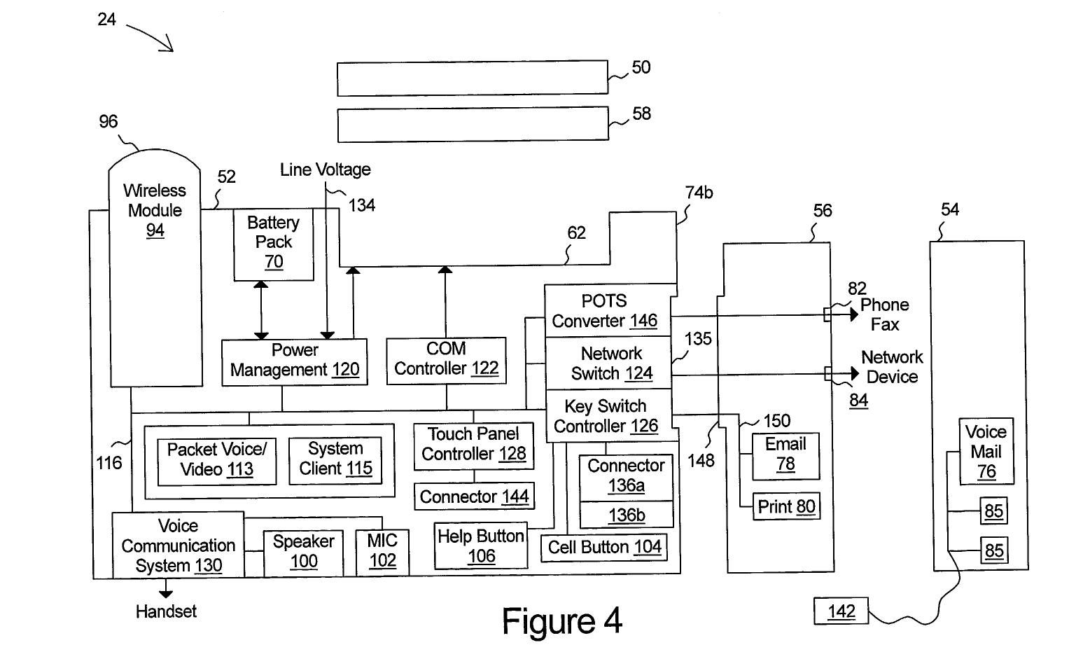

FIG. 4 shows a block diagram of the communication space station 24. The platform unit 52 includes an application controller 112 coupled to a local bus 116 that interconnects application controller 112 with a plurality of peripheral circuits that include a wireless module 94, a power management controller 120, a communication controller 122, a network switch controller 124, a key switch controller 126, a touch panel controller 128, a plain old telephone service (POTS) converter 146, and an audio communication system 130. The wireless module 94 operatively couples the platform unit 52 with the control unit 12 over the wireless Local Area Network 22 (both of FIG. 1). The application controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the communication space station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication controller 122 operatively couples the modular docking interface 58 and the modular subscriber device 50 to the controller 112 such that the platform 52 can exchange data with the modular subscriber device 50. In the exemplary embodiment the communication controller is a serial communication controller that enables the serial exchange of data with a compatible serial communication controller within the modular subscriber device 50 over a physical medium. Exemplary physical mediums include hardwired contacts, an infrared transmission, and RF transmission, however other physical mediums are envisioned and the selection of a physical medium is not critical to this invention. The communication control 122 also operatively couples the modular video camera 11 to the controller 112 such that the platform unit 52 may power the video camera 11 and receive the video image from the video camera 11.

The network switch controller 124 provides a network data port 84 which enables the application controller 112 to communicate with another network computing circuit over a network interface. The network switch controller 124 is coupled to a bus port 135 within the function specific docking platform 74b for coupling to a mating port 148 on the function specific module 56.

The key switch (e.g. button) controller 126 is coupled to: a connector 136a which in turn is coupled to a mating connector on the modular subscriber interface unit 60a (FIG. 3) for interconnecting the buttons 68 to the key switch controller 126; a connector 136b which in turn is coupled to a mating connector 142 on the function specific module 54 for interconnecting the buttons 76 and 85 to the key switch controller 126; the bus port 134 which in turn is coupled to a mating port 148 on the function specific module 56 for interconnecting the buttons 78 and 80 to the key switch controller 126; the cell button 104; and the help button 106. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 3) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The audio communication system 130 generates analog audio signals for driving the speaker 100 (or the speaker in the handset 98 of FIG. 3) and detects input from the microphone 102 (or the microphone in the handset 98) under the control the application controller 112.

The POTS converter circuit 146 provides a standard POTS port signal (e.g. tip and ring) for operation of a traditional telephone or a traditional fax machine coupled to a POTS port 82 on the function specific module 56. In operation the POTS converter 146 circuit interfaces between the POTS signal and the application controller 112.

The application controller 112 executes a packet audio/video communication client 113 and a client application 115. The packet audio/video communication client 113 provides for setting up and maintaining packet audio communications with the packet audio/video gateway 232 (FIG. 2) within the control unit 12. In the exemplary embodiment, the packet audio/video communication client 113 may be one of the commercially available clients utilizing established protocols.

The system client application 115 operates as a client to the web server application 230 (FIG. 3) within the control unit 12. The system client application 115 provides for the application controller 112 to: generate an image on the touch panel graphic display 72 or on the graphic display 90 on the subscriber device 50 in accordance with display content and a style sheet received from the control unit 12; output an audio stream file received from the control unit 12 through the audio system 130; execute processing steps in accordance with instructions received from the control unit 12; provide messages indicating subscriber actions (such as subscriber activation of the cell button 104, the help button 106, a touch panel virtual button, or any other button on the communication space station 24) to the web server application 230; activate the packet audio/video client 113 to set up a real time audio/video session with the packet audio/video gateway 232 (FIG. 2); identify the modular configuration or subscriber interface configuration of the communication space station 24 and report the configuration to the control unit 12; and report the coupling of (and decoupling of) a subscriber device 50 and/or modules to the platform 52 of the communication space station 24 to the control unit 12.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when the subscriber data assistant is coupled to the platform unit 52.

The subscriber data assistant controller 160 also operates a communication space station client application 174 for displaying multi-media communication management information under control the platform unit 52 when coupled to the platform unit 52. In the exemplary embodiment the communication space station client application 174 receives messages from the platform unit 52 in the form of tagged messages. After receipt of the tagged messages, the communication space station client application 174 builds a display document to display the communication management information represented by tagged content messages in accordance with a style sheet that is compatible with the size, resolution, and color depth of the display portion of touch panel 90. The display document is then displayed on the touch panel 90.

It should be appreciated that in additional to operating the drivers 176 and the communication space station client application 174, the subscriber data assistant controller 160 may optionally operate any of the software applications that are commercially available for portable data assistants (PDAs) which may include address book management software, calendar management software, and games. While operation of such PDA applications may be useful to the subscriber, it is not critical to the operation of the present invention.

The present caller managed hold system provides enhanced hold services to calling parties who access the multimedia communication management system by enabling the caller to customize the selection and presentation of program materials that they receive when in a hold state. In addition, the caller managed hold system records the choices made by the caller to be used in any subsequently received call from the caller that is placed in a hold state.

What is claimed:

1. A multi-media communication management system for operation with a plurality of subscriber stations, the multi-media communication management system comprising:
a network communication circuit for multi-media communication with said plurality of subscriber stations;
a service provider interface, connected to said network communication circuit, for multimedia communication with a plurality of remote communication devices over a service provider network;
a control module for establishing communication sessions with said plurality of subscriber stations over said network communication circuit and remote communication devices over said service provider network, said control module comprising:
call hold module for placing a remote communication device, connected to said service provider network, in an on-hold state, and
hold program selection means, responsive to said remote communication device being in an on-hold state, for providing on hold program selected from a plurality of program sources in response to the remote communication device.

2. The multi-media communication management system of claim 1, wherein said control module further comprises:
caller identification means for identifying said remote communication device that is placed in an on-hold state;
a storage for storing data records, each record associates a remote communication devices to one of the plurality of program sources; and
wherein said hold program selection means comprises:
caller match means for determining whether said storage associates a program source to said identified remote communication device that is placed in an on-hold state.

3. The multi-media communication management system of claim 2, wherein said hold program selection means further comprises:
program modification means, responsive to a modification signal from the caller for providing a menu of program choices to the identified remote communication device to enable the caller at said identified remote communication device to input data to select an on hold program.

4. The multi-media communication management system of claim 3, wherein said hold program selection means further comprises:
means for determining whether said identified remote communication device has video phone capabilities; and
means for providing the menu of program choices in a video format if the identified remote communication device has video phone capabilities.

5. The multi-media communication management system of claim 2, wherein said hold program selection means further comprises:
storage for storing a plurality of files, each file including at least one of a compressed audio program and a compressed audio/video program.

6. The multi-media communication management system of claim 6, wherein said hold program selection means further comprises:
real time streaming media client means for receiving a real time streaming media multi-cast from a remote program server coupled to the service provider network.

7. A method of providing a hold service in a multi-media communication management system for operation with a plurality of subscriber stations, the multi-media communication management system comprising a network communication circuit for multi-media communication with said plurality of subscriber stations, a service provider interface, connected to said network communication circuit, for multimedia communication with a plurality of remote communication devices over a service provider network and a control module for establishing communication sessions with said plurality of subscriber stations over said network communication circuit and remote communication devices over said service provider network, said method comprising:
placing a remote communication device, connected to said service provider network, in an on-hold state, and
providing a hold program selected from a plurality of hold programs in response to the remote communication device being placed in the on hold state and in response to an identification of the remote communication device.

8. The method of providing a hold service in a multi-media communication management system of claim 7, further comprising:
reading caller ID information to identify said remote communication device that is placed in an on-hold state;
storing in a storage data records, each data record associating a remote communication devices to one of the plurality of hold program; and
determining whether said memory contains a data record corresponding to said identified remote communication device that is placed in an on-hold state.

9. The method of providing a hold service in a multi-media communication management system of claim 8, further comprising:
providing a menu of program choices to the identified remote communication device to enable the caller at said identified remote communication device to input data to select an on hold program.

10. The method of providing a hold service in a multi-media communication management system of claim 9, further comprising:
determining whether said identified remote communication device has video phone capabilities; and
providing the menu of program choices in a video format if the identified remote communication device has video phone capabilities.

11. The method of providing a hold service in a multi-media communication management system of claim 8, further comprising:
storing a plurality of files, each file including at least one of a compressed audio program and a compressed audio/video program.

12. The method of providing a hold service in a multi-media communication management system of claim 11, further comprising:
receiving a real time streaming media multi-cast from a remote program server coupled to the service provider network.
